(19) United States
(12) Patent Application Publication
(10) Pub. No.: US 2009/0045716 A1
(43) Pub. Date: Feb. 19, 2009

(54) ELECTRON EMISSION DEVICE

(76) Inventors: Sam-Il Han, Yongin-si (KR); Sang-Hyuck Ahn, Yongin-si (KR); Sang-Jo Lee, Yongin-si (KR); Jin-Hui Cho, Yongin-si (KR); Sang-Ho Jeon, Yongin-si (KR); Su-Bong Hong, Yongin-si (KR)

Correspondence Address: CHRISTIE, PARKER & HALE, LLP, PO BOX 7068, PASADENA, CA, 91109-7068, US

(21) Appl. No.: 12/134,968

(22) Filed: Jun. 6, 2008

(30) Foreign Application Priority Data
Jul. 10, 2007 (KR) 10-2007-0069179

(51) Int. Cl. H01J 1/00

(52) U.S. Cl. 313/310

(57) ABSTRACT

An electron emission device includes i) a substrate, ii) a cathode electrode on the substrate, having a first opening, and comprising an ultraviolet non-transmitting material, iii) an electron emission region in the first opening and for emitting electrons, and iv) a gate electrode electrically insulated from the cathode electrode and having a second opening through which the electrons emitted from the electron emission region pass. The ultraviolet transmittance of the gate electrode is about 30% or more. A distance between a first imaginary line passing through a center of the electron emission region and normal to a plane surface of the substrate, and a second imaginary line passing through a center of the second opening and normal to the plane surface of the substrate is about 0.5 μm or less.

### CROSSED-REFERENCE TO RELATED APPLICATION

This application claims priority to and the benefit of Korean Patent Application No. 10-2007-0069179, filed on Jul. 10, 2007, in the Korean Intellectual Property Office, the entire content of which is incorporated herein by reference.

### BACKGROUND

1. Field of the Invention

The present invention relates to an electron emission device.

2. Description of Related Technology

Generally, a hot or cold cathode can be used as an electron emission source in an electron emission device. There are several types of cold cathode electron emission devices such as a field emitter array (FEA) electron emission device, a surface conduction emission (SCE) electron emission device, a metal-insulator-metal (MIM) electron emission device, a metal-insulator-semiconductor (MIS) electron emission device, and so on.

The FEA electron emission device is provided with driving electrodes (e.g., cathode and gate electrodes) for controlling electron emission units and emission of electrons thereof. Materials having a low work function and/or a high aspect ratio are used to form an electron emission unit in the FEA electron emission device. For example, carbon-based materials such as carbon nanotubes, graphite, and diamond-like carbon have been developed to be used in an electron emission unit in order for electrons to be easily emitted by an electrical field in a vacuum. The plurality of electron emission units are arrayed on a substrate to form an electron emission device, and the electron emission device is combined with another substrate on which phosphors and anode electrodes are formed to produce an electron emission display.

### SUMMARY OF INVENTION

An aspect of an embodiment of the present invention is directed to an electron emission device to which back exposure can be applied by using a metal having a proper ultraviolet transmittance as a material for a gate electrode.

An electron emission device according to an embodiment of the present invention includes i) a substrate, ii) a cathode electrode on the substrate, having a first opening, and comprising an ultraviolet non-transmitting material, iii) an electron emission region in the first opening and emitting electrons, and iv) a gate electrode electrically insulated from the cathode electrode and having a second opening through which the electrons emitted from the electron emission region pass. The ultraviolet transmittance of the gate electrode is at least about 30% (i.e., about 30% or more). A distance between a first imaginary line passing through a center of the electron emission region and normal to a plane surface of the substrate, and a second imaginary line passing through a center of the second opening and normal to the plane surface of the substrate is at most about 0.5 μm (i.e., about 0.5 μm or less).

The gate electrode may include a non-oxide metal. The non-oxide metal may include a material selected from the group consisting of Cr, Al, Mo, Ti, Yb, Ag, and Mg₁₀Ag₁, and combinations thereof. The thickness of the gate electrode may be at most about 400 Å (i.e., about 400 Å or less) if the non-oxide metal includes Cr. The thickness of the gate electrode may be at most about 250 Å (i.e., 250 Å or less) if the non-oxide metal includes Al. The thickness of the gate electrode may be at most about 200 Å (i.e., 200 Å or less) if the non-oxide metal includes Mg₁₀Ag₁.

The non-oxide metal may include Ag and at least one element selected from the group consisting of the Cr, Al, and Yb, and the one element and Ag are layered with each other in the gate electrode such that the one element is between the substrate and Ag. The thickness of the gate electrode may be at most about 30 nm (i.e., about 30 nm or less).

An electron emission device according to an embodiment of the present invention may further include an insulation layer electrically insulating the cathode electrode from the gate electrode. The insulation layer may be provided with a third opening communicating with the first and second openings, and a boundary of the third opening may surround or coincide with a boundary of the first opening at a plane where the insulation layer adjoins the cathode electrode.

The first opening may be filled with the electron emission region. The cathode electrode may include i) a resistance layer including an ultraviolet non-transmitting material, and ii) a conductive layer electrically connected to the resistance layer. The first opening may be located in the resistance layer.

An electron emission device according to an embodiment of the present invention may further include an ultraviolet non-transmitting focusing electrode located on the gate electrode and electrically insulated from the gate electrode. The ultraviolet transmittance of a portion of the cathode electrode which adjoins the electron emission region through the first opening may be at least about 30% (i.e., about 30% or more). The portion of the cathode electrode may include a non-oxide metal and the non-oxide metal may include at least one material selected from the group consisting of Cr, Al, Mo, Ti, Yb, Ag, and Mg₁₀Ag₁, and combinations thereof. The thickness of the portion of the cathode electrode may be at most about 30 nm (i.e., about 30 nm or less).

The cathode electrode may include i) main and isolated electrodes that are spaced apart from the main electrode, ii) a resistance layer that connecting the main and isolated electrodes and are made of an ultraviolet non-transmitting material, and iii) a conductive layer on the main electrode and adjoining the resistance layer. The ultraviolet transmittance of the isolated electrode may be about at least about 30% (i.e., about 30% or more). The isolated electrode may include a non-oxide metal. The non-oxide metal may include at least one material selected from the group consisting of Cr, Al, Mo, Ti, Yb, Ag, and Mg₁₀Ag₁, and combinations thereof. The thickness of the isolated electrode may be at most about 400 Å (i.e., 400 Å or less) if the non-oxide metal includes Cr. The thickness of the isolated electrode may be at most about 250 Å (i.e., 250 Å or less) if the non-oxide metal includes Al. The thickness of the isolated electrode may be at most about 200 Å (i.e., 200 Å or less) if the non-oxide metal includes Mg₁₀Ag₁.

The non-oxide metal may include Ag and at least one element of the Cr, Al, and Yb, and the at least one element and Ag may be layered in the isolated electrode such that at least one element is between the substrate and Ag. The thickness of the isolated electrode may be at most about 30 nm (i.e., 30 nm or less). The ultraviolet transmittance of the main electrode may be at least about 30% (i.e., 30% or more) and the main electrode may include a non-oxide metal.

An electron emission device according to another embodiment of the present invention includes i) a substrate, ii) a cathode electrode on the substrate, having a first opening, and comprising an ultraviolet non-transmitting material, iii) an electron emission region in the first opening and emitting electrons, and iv) a gate electrode electrically insulated from the cathode electrode and having a second opening through which the electrons emitted from the electron emission region pass. The ultraviolet transmittance of the gate electrode is at least about 30%. A distance between a center of the electron emission region and a center of the second opening is at most about 0.5 μm in a direction perpendicular to an extending direction of the cathode electrode.

### BRIEF DESCRIPTION OF THE DRAWINGS

FIG. 1 is a schematic exploded perspective view of a light emission device provided with an electron emission device according to a first embodiment of the present invention.

FIG. 2 is a schematic cross sectional view of the light emission device of FIG. 1.

FIGS. 3A to 3J are diagrams sequentially illustrating methods for manufacturing the electron emission device of FIG. 1.

FIG. 4 is a schematic cross-sectional view of a light emission device provided with an electron emission device according to a second embodiment of the present invention.

FIG. 5 is a schematic exploded perspective view of a light emission device provided with an electron emission device according to a third embodiment of the present invention.

FIGS. 6A to 6H are diagrams sequentially illustrating methods for manufacturing the electron emission device of FIG. 4.

FIGS. 7A to 7E are diagrams sequentially illustrating methods for manufacturing the electron emission device according to a fourth embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Hereinafter, like reference numerals refer to like elements.

In addition, when an element is referred to as being “on” another element, it can be directly on the another element or be indirectly on the another element with one or more intervening elements interposed therebetween. By contrast, when an element is referred to as being “directly on” another element, there are no intervening elements present.

Moreover, although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below can also be referred to as a second element, component, region, layer, or section without departing from the teachings of the present invention.

The terminology used herein is for the purpose of describing particular embodiments and is not intended to limit the invention. As used herein, the singular forms “a,” “an,” and “the” are intended to include the plural forms as well, unless the context clearly indicates otherwise. It will be further understood that the terms “comprises” and/or “comprising,” or “includes” and/or “including,” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper,” “over,” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein are interpreted (or understood) accordingly.

Unless otherwise defined, all terms (including technical and scientific terms) used herein have the same meaning as commonly understood by one skilled in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to figures that are schematic illustrations of idealized embodiments of the present invention. As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. As an example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

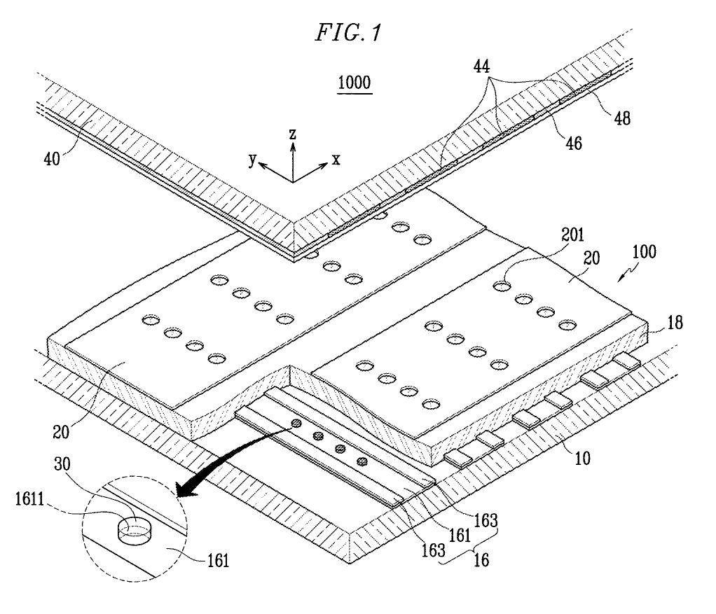

FIG. 1 shows an exploded view of a light emission device 1000 including an electron emission device 100 according to a first embodiment of the present invention. An enlarged circle in FIG. 1 shows an enlarged view of an electron emission region 30.

The light emission device 1000 is manufactured by combining the electron emission device 100 having a first substrate 10 on which a plurality of electron emission elements are formed with a second substrate 40 on which an anode electrode 48 and phosphor layers 44 are formed. Light is emitted through an outer surface of the second substrate 40.

As illustrated in FIG. 1, the electron emission device 100 includes the first substrate 10, a plurality of cathode electrodes 16, the electron emission regions 30, a first insulation layer 18, and a plurality of gate electrodes 20. If necessary, the electron emission device 100 may further include other suitable elements.

The cathode electrodes 16 are formed on the first substrate 10 and spaced apart from each other. Each of the cathode electrodes 16 extends along the y-axis. Each of the cathode electrodes 16 includes a resistance layer 161 and a conductive layer 163. The conductive layer 163 is electrically connected to the resistance layer 161. The resistance layers 161 are formed in a stripe pattern and formed of an ultraviolet non-transmitting material. For example, the resistance layer 161 may be formed of metal. By using the ultraviolet non-transmitting property of the resistance layer 161, the electron emission elements of the electron emission device 100 can be manufactured using back exposure. The conductive layer 163 is formed on the resistance layer 161 along both side edges (or edge portions) of the resistance layer 161, extending parallel with the resistance layer 161. Alternatively, in another embodiment, the conductive layer 163 may be formed on a rear surface of the resistance layer 161. Here, an ohmic loss can be reduced or minimized when a driving voltage is applied to each cathode electrode 16, because electric conductivity of the conductive layer 163 is higher than that of the resistance layer 161. In one embodiment, the conductive layer 163 is formed of a metal such as aluminum.

As illustrated in the enlarge circle of FIG. 1, the electron emission regions 30 are formed in the resistance layer 161. That is, the resistance layer 161 is provided with openings 1611 in which the respective electron emission regions 30 are placed. The electron emission regions 30 may be formed of a material, which emits electrons when an electric field is applied thereto under a vacuum atmosphere, such as a carbon-based material or a nanometer-sized material. For example, the electron emission regions 30 may include carbon nanotubes, graphite, graphite nanofibers, diamonds, diamond-like carbon, C₆₀, silicon nanowires, or combinations thereof. Alternatively, the electron emission regions 30 each may be formed as a molybdenum-based or silicon-based tip structure having a pointed end (e.g., a pointed distal end).

The insulation layer 18 is located on the cathode electrodes 16 to electrically insulate the gate electrodes 20. The insulation layer 18 is formed on an entire surface of the first substrate 10 while covering the cathode electrodes 16. The gate electrodes 20 are formed in a stripe pattern extending in a direction (the x-axis) crossing the cathode electrodes 16. Openings 201 through which electrons emitted from the electron emission region 30 pass are formed in the gate electrodes 20 at each crossed region of the gate and cathode electrodes 20 and 16. The crossed regions of the gate and cathode electrodes 20 and 16 may define pixel regions. A plurality of electrons are emitted from the electron emission regions 30 at the pixel regions.

The second substrate 40 is located to face the first substrate 10. The phosphor layers 44, black layer 46 and anode electrode 48 are provided on the second substrate 40. The black layer 46 is formed between the phosphor layers 44 to absorb external light, thus improving the contrast. Visible light is emitted from the phosphor layers 44 when the electrons collide with the phosphor layers 44. The phosphor layers 44 may use only white phosphor layers or use red, green and blue phosphor layers.

The anode electrode 48 is provided on the phosphor and black layers 44 and 46. The anode electrode 48 may be formed of a metal such as aluminum. Alternatively, the phosphor and black layers 44 and 46 may be provided on the anode electrode 48. Since a high voltage is applied to the anode electrode 48, the electrons emitted from the electron emission regions 30 are accelerated by the anode electrode 48 to collide with the phosphor layers 44.

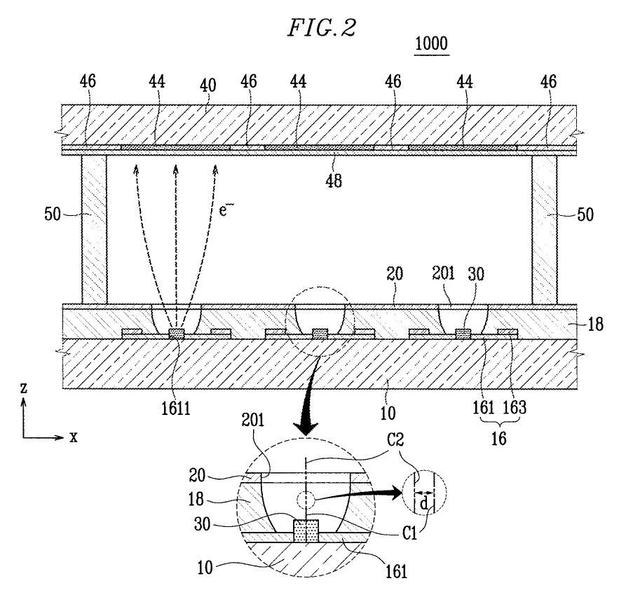

FIG. 2 shows schematically a sectional structure of the light emission device 1000 of FIG. 1. Enlarged circles in FIG. 2 show enlarged views of regions around the electron emission region 30.

The first and second substrates 10 and 40 are sealed together at their peripheries (or periphery regions) using a sealing member to form a vacuum envelope. An inner space of the vacuum envelope, enclosed by the first and second substrates 10 and 40 and the sealing member, is exhausted (or evacuated) to be kept to a degree of vacuum of about 10⁻⁶ torr.

As illustrated in FIG. 2, the first and second substrates 10 and 40 are spaced apart from each other by spacers 50. The spacers 50 endure (or resist) a compression force applied to the vacuum envelope and maintain a uniform gap between the first and second substrates 10 and 40. The spacers 50 are placed under the black layer 46 so as not to interfere with the phosphor layers 44.

The following will describe the operation of the above-described light emission device 1000. First, voltages (e.g., predetermined voltages) are applied to the cathode electrodes 16, the gate electrodes 20 and the anode electrode 48 from one or more external voltage sources. For example, in one embodiment, the cathode electrodes 16 are applied with a scan driving voltage, and the gate electrodes 20 are applied with a data driving voltage. Alternatively, in another embodiment, the gate electrodes 20 are applied with a scan driving voltage, and the cathode electrodes 16 are applied with a data driving voltage. The anode electrode 48 is applied with a voltage (e.g., a positive direct current voltage of about several hundred to several thousand volts).

An electric field is formed around the electron emission regions 30 at a pixel where a voltage difference between the cathode and gate electrodes 16 and 20 is greater than a threshold value. As a result, electrons are emitted from the electron emission regions 30. The emitted electrons collide with the phosphor layer 44 of the corresponding pixel by being attracted by the high voltage applied to the anode electrode 48. Therefore, visible light is emitted from the phosphor layer 44.

In the first embodiment of the present invention, the emission uniformity of the electron emission regions 30 can be enhanced by minimizing a misalignment between the openings 201 of the gate electrodes 20 and the electron emission regions 30. As a result, the luminance uniformity of the respective pixels can be improved. Moreover, by reducing the size of the opening 201, the electron emission regions 30 can be more formed in respective pixels, thereby enhancing the emission efficiency and luminance.

As illustrated in the enlarged circle of FIG. 2, a distance d between a first imaginary line C1 and a second imaginary line C2 may be 0.5 μm or less. Here, the first imaginary line C1 (shown as a dashed dot line in the drawing) passes through the center of the electron emission region 30 and is normal to a plane surface of the first substrate 10. In one embodiment, the plane surface of the first substrate 10 is a surface parallel with a direction of the x-axis, having the largest area among all side surfaces. The second imaginary line C2 (shown as a dashed two-dot line in the drawing) passes through the center of the opening 201 and is normal to the plane surface of the first substrate 10. When the distance d between the first and second imaginary lines C1 and C2 is within the above-described range, the center of the opening 201 and the center of the electron emission region 30 can be regarded as being properly (or accurately) aligned so that the above-described effect can be obtained.

In one embodiment, if the distance d between the first and second imaginary lines C1 and C2 is greater than 0.5 μm, the alignment between the center of the opening 201 and the center of the electron emission region 30 is not accurately realized as the alignment is out of the allowable error range. Therefore, the electron emission region 30 may contact the gate electrode 20. This causes the short circuit. As a result, the light emission device 1000 may malfunction and the emission uniformity of the electron emission regions 30 may be lowered, thereby deteriorating the luminance uniformity of each pixel.

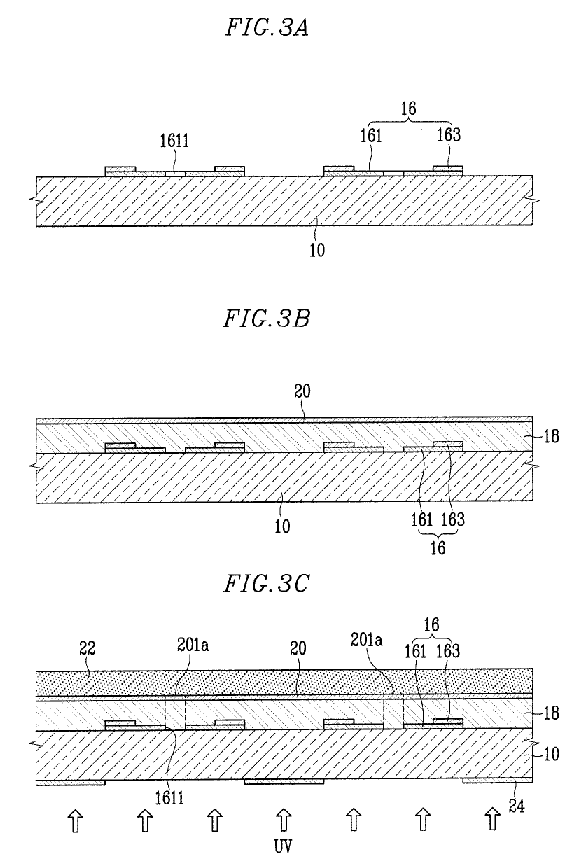

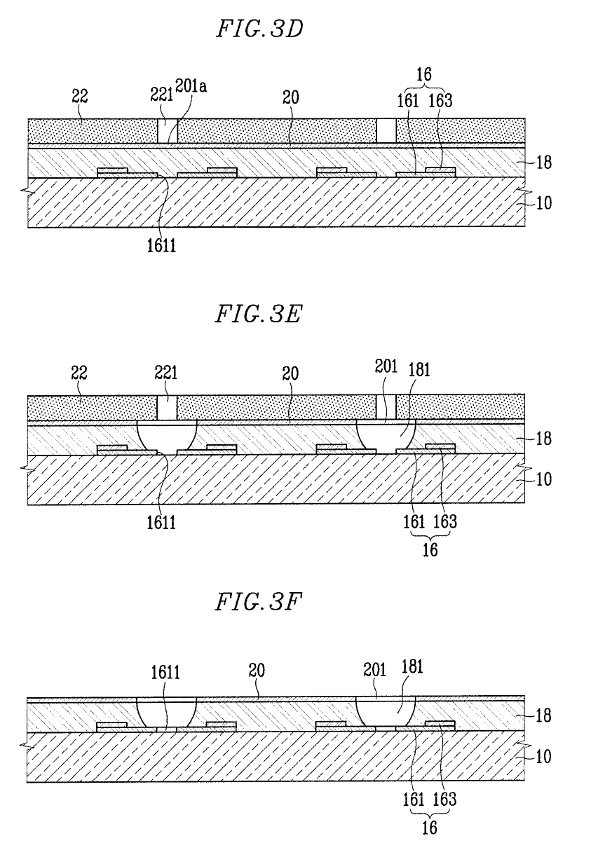

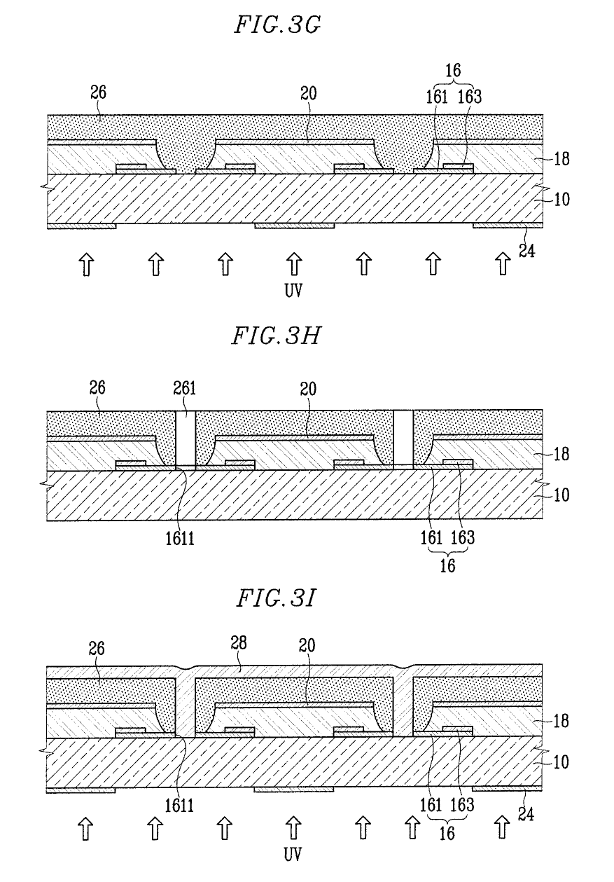

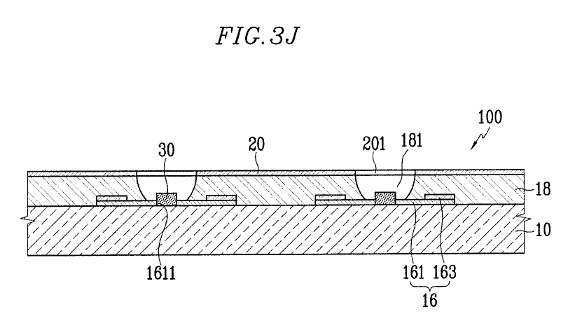

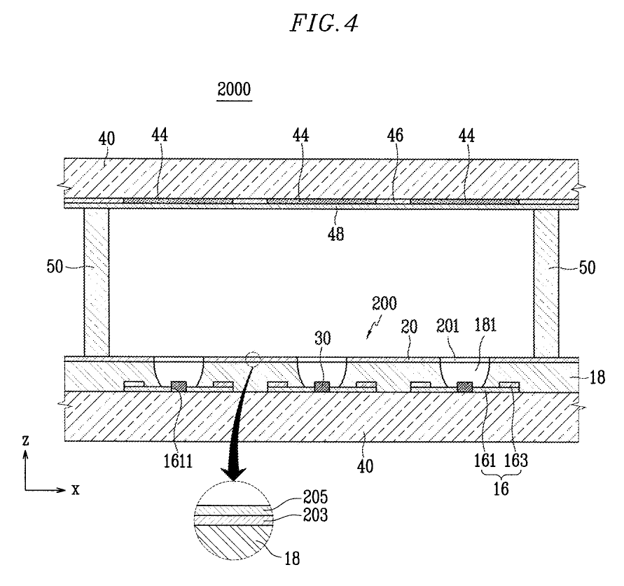

Processes of a method for manufacturing the electron emission device 100 according to the first embodiment of the present invention will now be described with reference to FIGS. 3A to 3J.

First, as illustrated in FIG. 3A, the resistance layers 161 of the stripe pattern are formed on the first substrate 10 by coating a resistive material on the first substrate 10 and patterning the coating layer. Openings 1611 are formed in the resistance layers 161. The openings 1611 are formed at locations where the electron emission regions 30 will be formed. The openings 1611 may be formed in, for example, a circular shape. The resistance layer 161 may be formed of amorphous silicon doped with p-type or n-type silicon and have a resistivity ranging from about 10,000 to 1,000,000 Ωcm. Next, the conductive layers 163 are formed on the resistance layers 161, thereby completing the formation of the cathode electrodes 16.

As illustrated in FIG. 3B, the insulation layer 18 having a thickness (or a predetermined thickness) is formed by depositing an insulation material on the first substrate 10 such that the insulation material covers the cathode electrodes 16. The insulation layer may be formed through chemical vapor deposition (CVD) or screen-printing. The insulation layer 18 is formed of an ultraviolet transmitting material. The gate electrodes 20 are formed on the insulation layer 18.

As illustrated in FIG. 3C, in an embodiment of the present invention, the openings of the gate electrodes 20 are formed using back exposure. As the electron emission regions and the openings of the gate electrodes 20 are formed using the back exposure, the electron emission regions 30 and the openings 201 of the gate electrodes 20 can be aligned with each other well. In case ultraviolet light is irradiated from a portion below the first substrate 10 to form the openings 201 of the gate electrodes 20 using the back exposure, opening portions 201a of the gate electrodes 20 should be formed of an ultraviolet transmitting material to transmit the ultraviolet light so that portions of a first photoresist layer 22 above the opening portions 201a of the gate electrodes 20 can absorb the ultraviolet light. The portions of the first photoresist layer 22, which absorb the ultraviolet light, are removed through a developing process and the openings 201 are formed in the gate electrodes 20 through an etching process.

When an intensity of the ultraviolet light increases for the back exposure, the amount of the ultraviolet light transmitting through the gate electrodes 20 also increases and thus the openings 201 of the gate electrodes 20 can be formed. However, since the manufacturing costs increase as the intensity of the ultraviolet light increases, the increase in the intensity of the ultraviolet light does have a limit. Therefore, the intensity of the ultraviolet light may be properly adjusted considering the manufacturing costs. The intensity of the ultraviolet light can be adjusted for the back exposure by forming the gate electrodes 20 using a material having proper ultraviolet transmittance. In one embodiment, the ultraviolet transmittance of the gate electrodes is 30% or more. In the context of the present embodiment, the ultraviolet transmittance can refer to an amount of the ultraviolet light transmitting through the gate electrodes 20 with respect to a total amount of the ultraviolet light. In one embodiment, when the ultraviolet transmittance is less than 30%, the intensity of the ultraviolet light has to increase for the back exposure. This causes an increase of the manufacturing costs.

Therefore, the gate electrodes 20 made of a metal having the ultraviolet transmittance of 30% or more, such as a non-oxide metal, are formed on the insulation layer 18. For example, the gate electrodes 20 may be made of a metal such as chromium (Cr), aluminum (Al), molybdenum (Mo), titanium (Ti), ytterbium (Yb), silver (Ag) and/or Mg₁₀Ag₁. Since these metal materials have relatively high electric conductivities, which are different from those of the oxide metals, they can minimize a driving voltage loss applied to the gate electrodes 20 as compared with indium tin oxide (ITO) or indium zinc oxide (IZO). The gate electrodes 20 may be formed of the above-described metal materials through physical vapor deposition (PVD) and/or chemical vapor deposition (CVD).

Meanwhile, the ultraviolet transmittance of the gate electrodes 20 may be adjusted by properly adjusting the thickness of one or more of the gate electrodes 20. In one embodiment, the thickness of the gate electrode 20 is about 30 nm or less. That is, in one embodiment, when the thickness of the gate electrode 20 is greater than about 30 nm, it is difficult for the ultraviolet light to transmit through the gate electrode 20. Therefore, it is difficult to form the openings 201 in the gate electrode 20.

In one embodiment, if the non-oxide metal for forming the gate electrodes 20 is chromium, the thickness of the gate electrode 20 is about 400 Å or less. That is, since chromium has relatively high ultraviolet transmittance, it is possible to make the gate electrode 20 relatively thick. In another embodiment, if the non-oxide metal for forming the gate electrodes 20 is aluminum, the thickness of the gate electrode 20 is about 250 Å or less. That is, since aluminum has relatively low ultraviolet transmittance, the gate electrode should be relatively thin. Furthermore, in another embodiment, if the non-oxide metal for forming the gate electrodes 20 is Mg₁₀Ag₁, the thickness of the gate electrode 20 is about 200 Å or less since the ultraviolet transmittance of the Mg₁₀Ag₁ is even lower than aluminum.

When ITO instead of the non-oxide metal is used as a material for the gate electrodes for the back exposure, the manufacturing cost increases. After the photoresist layer formed on the gate electrodes formed of ITO is back irradiated and developed to form the openings in the gate electrodes, the opening portions of the gate electrodes are etched. In this case, since the pattern of the gate electrodes is irregular due to an ITO crystal grain, there is a problem in that edges of the openings of the gate electrodes become rough. In addition, since ITO has lower thermal conductivity and lower electric conductivity as compared with metal, it is difficult to dissipate the heat generated in the electron emission device and thus it is impossible to improve the display quality. Moreover, when an electrode formed of aluminum is used as an auxiliary electrode of the gate electrode formed of the ITO to improve the electric conductivity of the gate electrode, a separate mask is required to form the auxiliary electrode. In addition, a galvanic phenomenon where the auxiliary electrode and the indium tin oxide are detached from each other may occur. Because of the above issues, the gate electrodes in an embodiment of the present invention are made of a non-oxide metal.

As illustrated in FIG. 3C, the first photoresist layer 22 is formed on the gate electrodes 20 to cover the gate electrode 20. The first photoresist layer 22 is a positive type where an exposed portion is patterned and removed. Next, after light interception masks 24 are positioned on a rear surface of the first substrate 10 to correspond to respective portions between the cathode electrodes 16, the ultraviolet light is irradiated to the rear surface of the first substrate 10. In this case, since the resistance layers 161 do not transmit the ultraviolet light, only the ultraviolet light passing through the openings 1611 reaches the first photoresist layer 22 so that selective portions of the first photoresist layer 22 can be exposed to the ultraviolet light.

As illustrated in FIG. 3D, after the light interception masks 24 are removed, the exposed portions of the first photoresist layer 22 are developed to form openings 221 corresponding to the respective opening portions 201a of the gate electrodes 20. Therefore, the opening portions 201a of the gate electrodes 20 can be etched through the openings 221 of the photoresist layer 22.

As illustrated in FIG. 3E, the openings 201 are formed in the gate electrodes 20 by etching the opening portions 201a exposed by the openings 221 of the photoresist layer 22. Next, the openings 181 are formed in the first insulation layer 18 by etching the first insulation layer 18 exposed by the openings 201 and 221. When the openings 181 and 201 are formed, a boundary of the opening 181 surrounds a boundary of the opening 1611 at a plane where the first insulation layer 18 adjoins the resistance layer 161. In addition, the boundary of the opening 181 may coincide with the boundary of the opening 1611. In this case, a second photoresist layer may be formed in the openings 181 in the succeeding process to form the electron emission elements in the openings 1611.

When the insulation layer 18 is wet-etched, openings 181 larger than the openings 201 of the gate electrodes 20 may be formed at an upper portion of the insulation layer 18 due to the isotropic etching property. In this case, after the insulation layer 18 is wet-etched, the gate electrodes 20 are further etched to make the boundaries of the openings 201 of the gate electrodes 20 coincide with the respective openings 181 of the insulation layer 18.

As illustrated in FIG. 3F, after the openings 201 and 181 are formed, the first photoresist layer 22 is removed. Then, the electron emission regions 30 aligned with the openings 201 of the gate electrodes 20 are formed.

As illustrated in FIG. 3G, a second photoresist layer 26 functioning as a sacrifice layer is formed on the gate electrodes 20. The second photoresist layer 26 is a positive type where the exposed portion is patterned and removed. Next, after light interception masks 24 are positioned on a rear surface of the first substrate 10 to correspond to respective portions between the cathode electrodes 16, the ultraviolet light is irradiated to the rear surface of the first substrate 10. In this case, since the resistance layers 161 do not transmit the ultraviolet light, only the ultraviolet light passing through the openings 1611 reaches the second photoresist layer 26 so that selective portions of the second photoresist layer 26 are exposed to the ultraviolet light.

Therefore, as illustrated in FIG. 3H, the exposed second photoresist layer 26 is developed to form the openings 261 therein. A boundary of the opening 261 coincides substantially with the boundary of the opening 1611 at a plane where the first insulation layer 18 adjoins the resistance layer 161. Therefore, the second photoresist layer 26 allows the openings 1611 of the resistance layers 161, in which the electron emission regions 30 will be formed, to be exposed.

Next, as illustrated in FIG. 3I, a paste mixture 28 including an electron emission material and a photoresist material is deposited on the second photoresist layer 26 through screen-printing. Then, after light interception masks 24 are positioned on a rear surface of the first substrate 10, the ultraviolet light is irradiated to the rear surface of the first substrate 10. In this case, since the resistance layers 161 do not transmit the ultraviolet light, the paste mixture filled in the openings 1611 are selectively hardened. The paste mixture that is not hardened is removed through a developing process and the second photoresist layer 26 is delaminated. Next, the hardened paste is dried and sintered.

Therefore, as illustrated in FIG. 3J, the electron emission device 100 having the electron emission regions 30 formed in the openings 1611 can be manufactured. Since the electron emission regions 30 are hardened through back exposure, the adhering force to the first substrate 10 is relatively high (or superior). If necessary, the electron emission efficiency of the electron emission regions 30 can be enhanced by exposing electron emission materials to surfaces of the electron emission regions 30 through an activation process where a pressure-sensitive tape is adhered to the first substrate 10 and then removed.

As illustrated in FIGS. 3A to 3J, since the openings 201 of the gate electrodes 20 and the electron emission regions 30 are formed by commonly using the openings 1611 of the resistance layers 161, the centers of the openings 201 can be accurately aligned with the respective centers of the electron emission regions 30. Therefore, the short circuit caused by the contact between the gate electrode 20 and the electron emission region 30 can be reduced or prevented.

FIG. 4 shows a light emission device 2000 provided with an electron emission device 200 according to a second embodiment of the present invention. In an enlarged circle of FIG. 4, a gate electrode 20 is shown in an enlarged state. Since the light emission device 2000 shown in FIG. 4 is similar to the light emission device of the first embodiment, like reference numerals refer to like elements, and the detailed description thereof will not be provided again.

As illustrated in the enlarged circle of FIG. 4, the gate electrode 20 may include first and second metal layers 203 and 205 that are layered on the first insulation layer 18 in order. For example, aluminum may be used for the first metal layer 203 while silver may be used for the second metal layer 205. Alternatively, ytterbium may be used for the first metal layer 203 while silver may be used for the second metal layer 205. In addition, chromium may be used for the first metal layer 203 while silver may be used for the second metal layer 205. As described above, by forming the gate electrodes 20 by layering metal materials, the gate electrode 20 can be adjusted to a desired thickness.

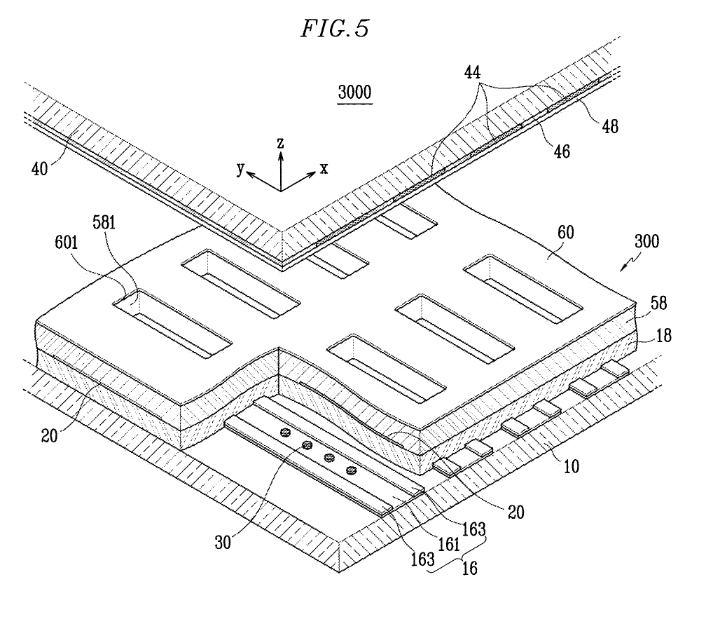

FIG. 5 schematically shows an exploded perspective view of a light emission device 3000 provided with an electron emission device 300 according to a third embodiment of the present invention. Since a structure of the light emission device 3000 shown in FIG. 5 is substantially identical to that of the electron emission device 100 of FIG. 1 except for a focusing electrode 60 and a second insulation layer 58, like reference numerals refer to like elements, and detailed description thereof will not be provided again.

As illustrated in FIG. 5, the second insulation layer 58 is further provided on the gate electrodes 20 to electrically insulate the gate electrodes 20 from the focusing electrode 60. Openings 581 and openings 601 are respectively formed in the second insulation layer 58 and the focusing electrode 60 to allow the electrons emitted from the electron emission regions 30 to pass therethrough. When a driving voltage is applied to the focusing electrode 60, the electrons are focused (or converged) by the focusing electrode 60 and thus the display quality of the light emission device 3000 can be improved.

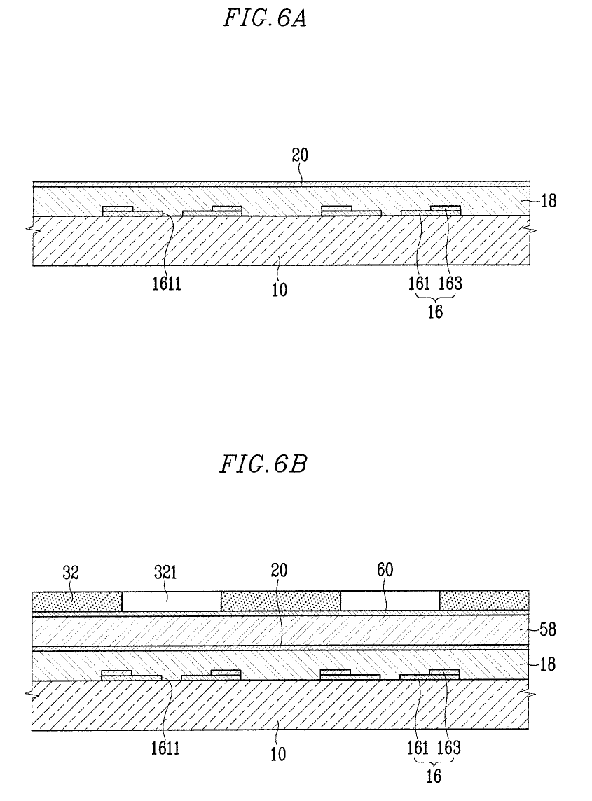

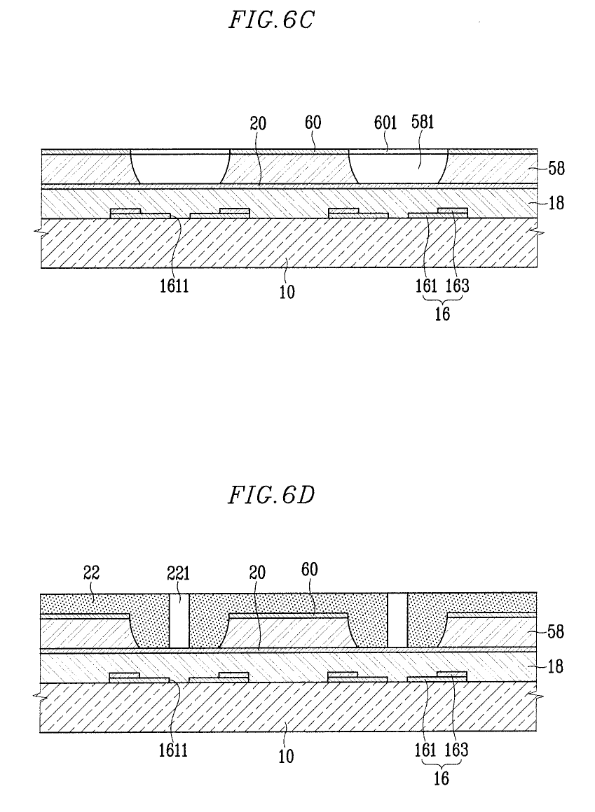

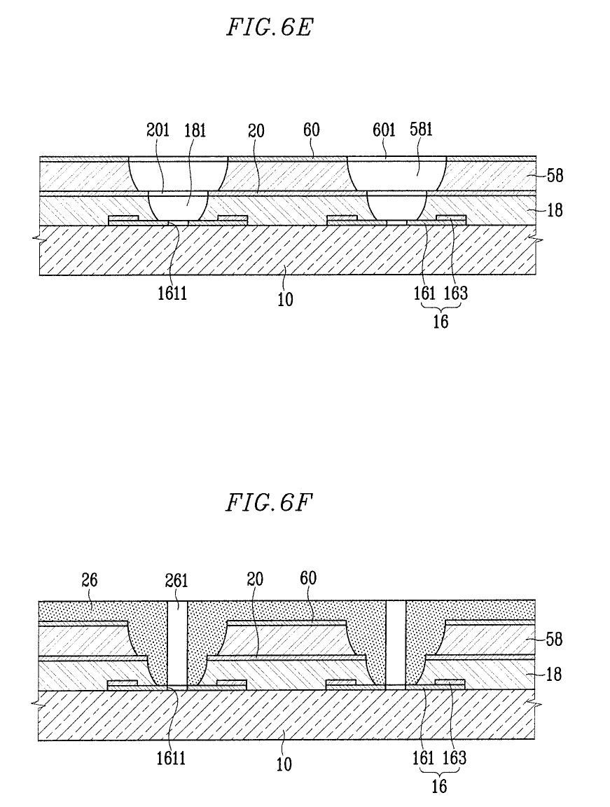

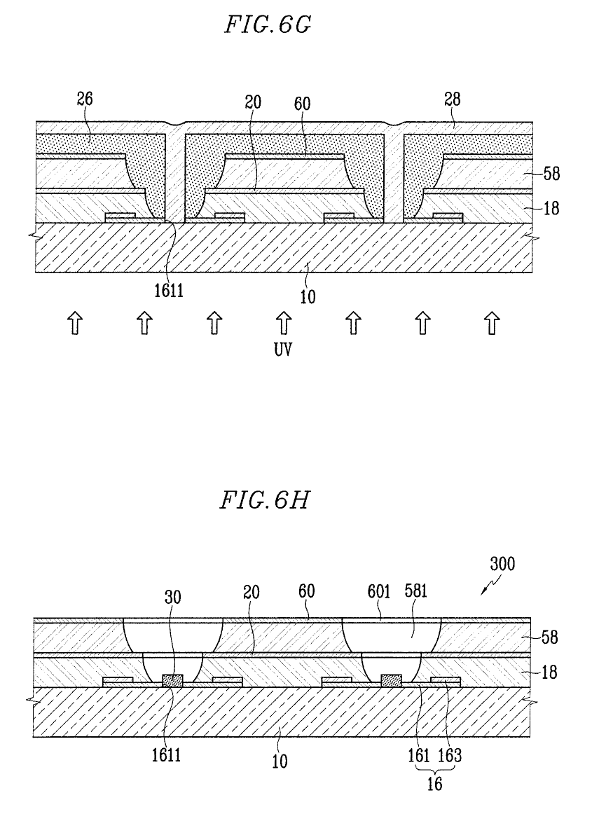

FIGS. 6A to 6H illustrate methods for sequentially manufacturing the electron emission device 300 of FIG. 5. Since the processes for manufacturing the electron emission device 300 are similar to the processes for manufacturing the electron emission device 100 of FIGS. 3A to 3J, those processes that are substantially the same as those shown and described before will not be provided again.

First, as illustrated in FIG. 6A, the cathode electrodes 16 each including the resistive and conductive layers 161 and 163 are formed on the first substrate 10. Next, the first insulation layer 18 formed of a transparent material is formed on an entire surface of the first substrate 10 to cover the cathode electrodes 16. A metal coating layer is coated on the first insulation layer 18 and patterned to form the gate electrodes 20 crossing the cathode electrodes 16.

Next, as illustrated in FIG. 6B, the second insulation layer 58 is formed on the gate electrodes 20 and the focusing electrode 60 is formed on the second insulation layer 58. A mask layer 32 is formed on the focusing electrode 60 and patterned to form openings 321. In this case, the openings 321 of the mask layer 32 are designed to be larger than the openings 1611 of the resistance layer 161 so that the openings formed in the focusing electrode 60 and second insulation layer 58 can be formed to be larger than the openings 1611 of the resistance layer 161.

As illustrated in FIG. 6C, portions of the focusing electrode 60, which are exposed by the openings 321 of the mask layer 32, and portions of the second insulation layer 58, which correspond to the exposed portions of the focusing electrode 60, are etched in order. Therefore, the openings 601 and the openings 581 are respectively formed in the focusing electrode 60 and the second insulation layer 58. Next, as shown in FIG. 6D, a first photoresist layer 22 is formed on an entire surface of the first substrate 10 to cover the focusing electrodes 60. Ultraviolet light is irradiated to a rear surface of the first substrate 10 so that the first photoresist layer 22 is selectively exposed through the openings 1611 of the resistance layer 161.

Then, as illustrated in FIG. 6D, the exposed first photoresist layer 22 is developed to form openings 221 in the first photoresist layer 22. According to the present embodiment, since the focusing electrode 60 does not transmit the ultraviolet light, the light interception masks (see light interception masks in FIG. 3C) used in the foregoing embodiment are not required. Next, portions of the gate electrodes 20, which are exposed by the openings 221 of the first photoresist layer 22, and portions of the first insulation layer 18, which correspond to the exposed portions of the gate electrodes 20, are etched in order.

Therefore, as illustrated in FIG. 6E, after the openings 201 and the openings 181 are respectively formed in the gate electrodes 20 and the first insulation layer 18, the first photoresist layer 22 is removed. Next, as shown in FIG. 6F, a second photoresist layer 26 is formed on the focusing electrode 60, and then ultraviolet light is irradiated to a rear surface of the first substrate 10 so that the second photoresist layer 26 is selectively exposed. Then, the exposed second photoresist layer 26 is developed.

In this case, as illustrated in FIG. 6F, openings 261 are formed in the second photoresist layer 26. Therefore, only the openings 1611 in which the electron emission regions 30 will be placed are selectively exposed through the openings 261 of the second photoresist layer 26.

Next, as illustrated in FIG. 6G, after a paste mixture 28 including an electron emission material and a photoresist material is deposited on the second photoresist layer 26 through screen-printing, the ultraviolet light is irradiated to the past mixture 28 through the rear surface of the first substrate 10. Then, the paste mixture 28 is developed.

By baking the developed paste mixture 28, as illustrated in FIG. 6H, the electron emission regions 30 are formed in the openings 1611 of the resistance layer 161. By using the above method, the electron emission device 300 according to an embodiment of the present invention may be manufactured.

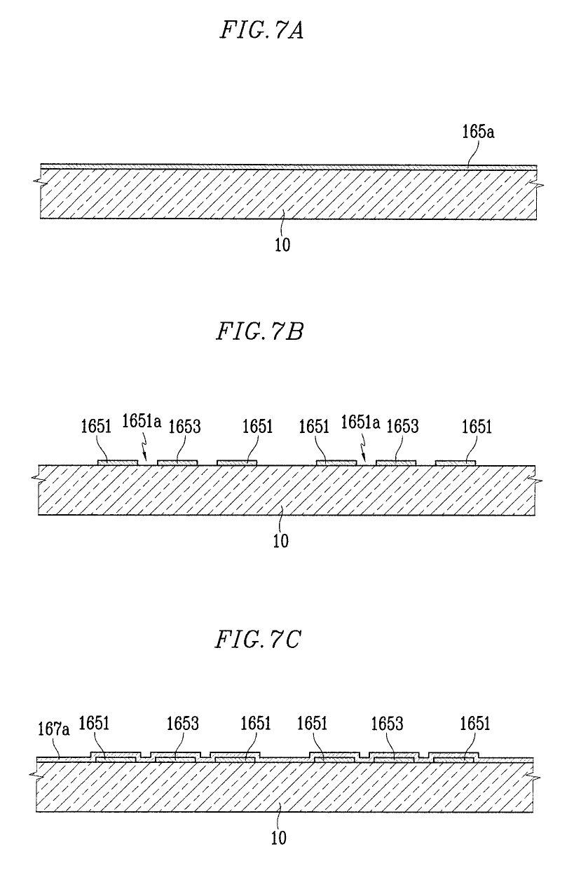

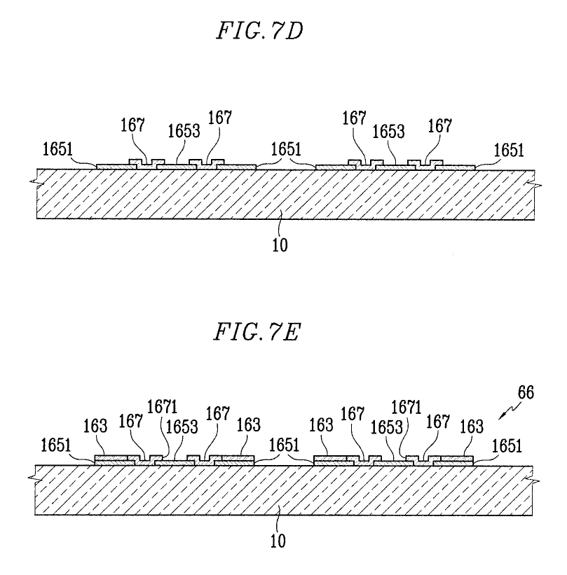

FIGS. 7A to 7E illustrate a method for manufacturing an electron emission device 400 according to a fourth embodiment of the present invention. Since the method for manufacturing the electron emission device 400 according to the fourth embodiment of the present invention is substantially the same as those of the electron emission devices 100 and 300 according to the first to third embodiments of the present invention except for a method for manufacturing a cathode electrode 66 (shown in FIG. 7E), like reference numerals refer to like elements and detailed description thereof will not be provided again.

As illustrated in FIG. 7A, a metal layer 165a whose ultraviolet transmittance is about 30% or more is deposited on the substrate 10. The material, thickness and characteristics of the metal layer 165a are the same (or substantially the same) as those of the gate electrode 20 included in the electron emission devices 100 and 300 according to the first to third embodiments of the present invention. Therefore, detailed description thereof will not be provided again.

Next, as illustrated in FIG. 7B, the metal layer 165a (shown in FIG. 7A) is patterned to form a main electrode 1651 and an isolated electrode 1653. An opening 1651a is formed in the main electrode 1651, and the isolated electrode 1653 is formed in the opening 1651a. Therefore, the main electrode 1651 and the isolated electrode 1653 are spaced apart from each other by the opening 1651a. Since the isolated electrode 1653 is a remaining portion after the metal layer 165a is patterned, the material, thickness and characteristics of the isolated electrode 1653 are the same (or substantially the same) as those of the metal layer 165a.

Next, as illustrated in FIG. 7C, an ultraviolet non-transmitting material 167a is coated on the entire surface of the substrate 10 by using screen printing method and etc. Then, photoresist is coated on the substrate 10 and a mask for blocking light is attached to the substrate 10 to cover a portion corresponding to the opening 1651a. Next, the mask for blocking light is removed and the substrate 10 is developed after ultraviolet ray is irradiated upon the substrate 10.

Then, as illustrated in FIG. 7D, a resistance layer 167 is formed to electrically connect the main electrode 1651 and the isolated electrode 1653. Voltage applied to the main electrode 1651 can be supplied to the isolated electrode 1653 through the resistance layer 167. Therefore, light emission region to be formed on the isolated electrode 1653 can be driven and then electrons can be emitted.

Finally, as illustrated in FIG. 7E, a conductive layer 163 is formed on the main electrode 1651 by using a sputtering method, and/or other suitable methods. The main electrode 1651 is formed by using a conductive layer 165a (shown in FIG. 7A) whose ultraviolet transmittance is about 30% or more, and the conductive layer 163 is formed thereon. Therefore, the main electrode 1651 and the conductive layer 163 are not detached from each other. In other words, aluminum is commonly used for the conductive layer 163, chemical attraction at a boundary between the main electrode 1651 and the conductive layer 163 is good since both of them are metals. Therefore, durability of the cathode electrode 66 can be improved.

In a conventional example, a battery phenomenon can occur because an aluminum film as a conductive layer is formed on the main electrode formed of ITO by using a sputtering method, and/or other suitable methods. That is, since chemical attraction between ITO and aluminum layer is not good, a phenomenon in which an aluminum layer is detached from ITO can occur. Therefore, durability of the cathode electrode is deteriorated. However, in the fourth embodiment of the present invention, as described above, the above problems do not occur since the main electrode 1651 is formed by using the metal layer 165a (shown in FIG. 7A) whose ultraviolet transmittance is about 30% or more.

If the cathode electrode 66 manufactured by the above method is used, the electron emission devices 100 and 300 according to the first to third embodiments of the present invention may be manufactured by using back exposure. That is, back exposure can be processed since a portion adjoining an electron emission region 30 to be formed in succeeding processes is exposed outside through the opening 1671. Ultraviolet ray should pass through an area surrounded by a boundary of the opening 1671 while not passing through regions that are outside of the opening 1671.

The ultraviolet rays do not pass through outside of the opening 1671 since the resistance layer 167 is made of ultraviolet non-transmitting materials and the conductive layer 163 is made of a metal. However, since the ultraviolet transmittance of the main electrode 1651 is about 30% or more, ultraviolet rays can pass through the main electrode 1651. Therefore, the conductive layer 163 is arranged to adjoin the resistance layer 167 to block the ultraviolet rays. As a result, ultraviolet rays cannot transmit since a gap is not formed between the conductive layer 163 and the resistance layer 167. Therefore, the cathode electrode 66 manufactured by the methods illustrated in FIGS. 7A to 7E may be used in the electron emission devices 100 and 300 according to the first to third embodiments of the present invention.

Embodiments of the present invention will be described in more detail with reference to the following examples. These examples are merely to illustrate the present invention and the present invention is not limited thereto.

### EXAMPLE A

The following tests for determining ultraviolet transmittance of metal that can replace ITO as a material for the gate electrodes were conducted.

A substrate, having a 370 mm×400 mm size and on which an insulation layer is formed, was loaded into a vacuum chamber. After loading the substrate into the vacuum chamber, a degree of vacuum of the vacuum chamber was adjusted to be less than 10⁻⁵ torr. A base metal of 200 g for forming a gate electrode was loaded into the vacuum chamber. The base metal was then vaporized from the base metal for 9 minutes using a sputtering method to form the gate electrode on the insulation layer. Photoresist was coated on the gate electrode and masks for blocking light were attached on a bottom surface of the substrate. Then, ultraviolet light was irradiated to the bottom (or rear) surface of the substrate for 4 minutes with a rate of 25 mW/sec. Next, the substrate was developed to form openings in the photoresist. The test was conducted using a plurality of base metals having different ultraviolet transmittance.

### EXAMPLE 1

The gate electrode was manufactured using metal having ultraviolet transmittance of 20%. Other test conditions were substantially identical to those of Example A.

### EXAMPLE 2

The gate electrode was manufactured using metal having ultraviolet transmittance of 25%. Other test conditions were substantially identical to those of Example 1.

### EXAMPLE 3

The gate electrode was manufactured using metal having ultraviolet transmittance of 30%. Other test conditions were substantially identical to those of Example 1.

### EXAMPLE 4

The gate electrode was manufactured using metal having ultraviolet transmittance of 35%. Other test conditions were substantially identical to those of Example 1.

### EXAMPLE 5

The gate electrode was manufactured using metal having ultraviolet transmittance of 40%. Other test conditions were substantially identical to those of Example 1.

### EXAMPLE 6

The gate electrode was manufactured using metal having ultraviolet transmittance of 45%. Other test conditions were substantially identical as those of Example 1.

### EXAMPLE 7

The gate electrode was manufactured using metal having ultraviolet transmittance of 50%. Other test conditions were substantially identical to those of Example 1.

### Result

Shapes of the openings formed according to Examples 1 to 7 were observed. The shapes of the openings according to Examples 1 to 7 are illustrated in the following Table 1.

TABLE 1

| Example | Ultraviolet | forming status | |
|---|---|---|---|
| No. | Transmittance | of openings | Remark |
| 1 | 20% | Bad | openings were not formed |
| 2 | 25% | Bad | openings were |
| | | | incompletely formed |
| 3 | 30% | Good | openings were formed |
| 4 | 35% | Good | openings were formed |
| 5 | 40% | Good | openings were formed |
| 6 | 45% | Good | openings were formed |
| 7 | 50% | Good | openings were formed |

As illustrated in Table 1, in case of Examples 1 and 2, the openings were not formed well since the ultraviolet light cannot sufficiently transmit through the gate electrode. In case of Example 1, no opening was formed. In case of Example 2, the openings were not completely formed. It can be noted from the test result illustrated in Table 1 that the openings can be appropriately formed in the gate electrode when metal having ultraviolet transmittance of 30% or more is used for the gate electrode.

### EXAMPLE B

In order to determine a proper thickness of the gate electrode, the following tests were conducted using base metal having ultraviolet transmittance of 30%.

### EXAMPLE 8

Except for time taken for irradiating with ultraviolet light, the test was conducted under test conditions that were substantially the same as Example 1. The ultraviolet light was irradiated with a power rate of 25 mW/sec to form a gate electrode having a thickness of 5 nm.

### EXAMPLE 9

Except for time taken for irradiating with ultraviolet light, the test was conducted under test conditions that were substantially the same as Example 1. The ultraviolet light was irradiated with a power rate of 25 mW/sec to form a gate electrode having a thickness of 10 nm.

### EXAMPLE 10

Except for time taken for irradiating with ultraviolet light, the test was conducted under test conditions that were substantially the same as Example 1. The ultraviolet light was irradiated with a power rate of 25 mW/sec to form a gate electrode having a thickness of 20 nm.

### EXAMPLE 11

Except for time taken for irradiating with ultraviolet light, the test was conducted under test conditions that were substantially the same as Example 1. The ultraviolet light was irradiated with a power rate of 25 mW/sec to form a gate electrode having a thickness of 25 nm.

### EXAMPLE 12

Except for time taken for irradiating with ultraviolet light, the test was conducted under test conditions that were substantially the same as Example 1. The ultraviolet light was irradiated with a power rate of 25 mW/sec to form a gate electrode having a thickness of 30 nm.

### EXAMPLE 13

Except for time taken for irradiating with ultraviolet light, the test was conducted under test conditions that were substantially the same as Example 1. The ultraviolet light was irradiated with a power rate of 25 mW/sec to form a gate electrode having a thickness of 40 nm.

### EXAMPLE 14

Except for time taken for irradiating with ultraviolet light, the test was conducted under test conditions that were substantially the same as Example 1. The ultraviolet light was irradiated with a power rate of 25 mW/sec to form a gate electrode having a thickness of 50 nm.

Shapes of the openings formed according to Examples 8 to 14 were observed. The shapes of the openings according to Examples 8 to 14 are illustrated in the following table 1.

TABLE 2

| Example | | | forming status of | |
|---|---|---|---|---|
| No. | thickness | | openings | Remark |
| 8 | 5 | nm | Good | openings were formed |
| 9 | 10 | nm | Good | openings were formed |
| 10 | 20 | nm | Good | openings were formed |
| 11 | 25 | nm | Good | openings were formed |
| 12 | 30 | nm | Good | openings were formed |
| 13 | 40 | nm | Bad | openings were incompletely |
| | | | | formed |
| 14 | 50 | nm | Bad | openings were not formed |

According to the test result, it can be noted that the thickness of the gate electrode is appropriately set to transmit approximately 30-90% of a wavelength within an ultraviolet range absorbed by the photoresist. In addition, even when other base metals obtained through Example A and having different proper ultraviolet transmittance were used, substantially the same result could be obtained.

As described above, by forming the gate electrode using metal having proper ultraviolet transmittance, the shapes of the edges of the openings formed by etching can be uniformly realized. Since the ultraviolet transmitting metal has relatively high (or superior) electron conductivity as compared with ITO, the manufacturing cost can be reduced while the display quality is improved.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electron emission device comprising:
a substrate;
a cathode electrode on the substrate and having a first opening, the cathode electrode comprising an ultraviolet non-transmitting material;
an electron emission region in the first opening and for emitting electrons; and
a gate electrode electrically insulated from the cathode electrode and having a second opening through which the electrons emitted from the electron emission region pass, the gate electrode having an ultraviolet transmittance of at least about 30%,
wherein a distance between a first imaginary line passing through a center of the electron emission region and normal to a plane surface of the substrate, and a second imaginary line passing through a center of the second opening and normal to the plane surface of the substrate is at most about 0.5 μm.

2. The electron emission device of claim 1, wherein the gate electrode comprises a non-oxide metal.

3. The electron emission device of claim 2, wherein the non-oxide metal comprises a material selected from the group consisting of Cr, Al, Mo, Ti, Yb, Ag, Mg₁₀Ag₁, and combinations thereof.

4. The electron emission device of claim 3, wherein the non-oxide metal comprises Cr, and a thickness of the gate electrode is at most about 400 Å.

5. The electron emission device of claim 3, wherein the non-oxide metal comprises Al, and a thickness of the gate electrode is at most about 250 Å.

6. The electron emission device of claim 3, wherein the non-oxide metal comprises Mg₁₀Ag₁, and a thickness of the gate electrode is at most about 200 Å.

7. The electron emission device of claim 3, wherein the non-oxide metal comprises Ag and at least one element selected from the group consisting of the Cr, Al, and Yb, and the at least one element and Ag are layered with each other in the gate electrode such that the at least one element is between the substrate and Ag.

8. The electron emission device of claim 1, wherein a thickness of the gate electrode is at most about 30 nm.

9. The electron emission device of claim 1, further comprising an insulation layer electrically insulating the cathode electrode from the gate electrode,
wherein the insulation layer has a third opening communicating with the first and second openings, and a boundary of the third opening surrounds or coincides with a boundary of the first opening at a plane where the insulation layer adjoins the cathode electrode.

10. The electron emission device of claim 1, wherein the first opening is filled with the electron emission region.

11. The electron emission device of claim 1, wherein the cathode electrode comprises:
a resistance layer including an ultraviolet non-transmitting material; and
a conductive layer electrically connected to the resistance layer,
wherein the first opening is located in the resistance layer.

12. The electron emission device of claim 1, further comprising an ultraviolet non-transmitting focusing electrode located on the gate electrode and electrically insulated from the gate electrode.

13. The electron emission device of claim 12, wherein the ultraviolet transmittance of a portion of the cathode electrode which adjoins the electron emission region through the first opening is at least about 30%.

14. The electron emission device of claim 13, wherein the portion of the cathode electrode comprises a non-oxide metal and wherein the non-oxide metal comprises at least one material selected from the group consisting of Cr, Al, Mo, Ti, Yb, Ag, Mg₁₀Ag₁, and combinations thereof.

15. The electron emission device of claim 13, wherein a thickness of the portion of the cathode electrode is at most 30 nm.

16. The electron emission device of claim 1, wherein the cathode electrode comprises:
a main electrode and an isolated electrode spaced apart from the main electrode;
a resistance layer connecting the main and isolated electrodes and comprising an ultraviolet non-transmitting material; and
a conductive layer on the main electrode and adjoining the resistance layer,
wherein the ultraviolet transmittance of the isolated electrode is at least about 30%.

17. The electron emission device of claim 16, wherein the isolated electrode comprises a non-oxide metal.

18. The electron emission device of claim 17, wherein the non-oxide metal comprises at least one material selected from the group consisting of Cr, Al, Mo, Ti, Yb, Ag, Mg₁₀Ag₁, and combinations thereof.

19. The electron emission device of claim 18, wherein the non-oxide metal comprises Cr, and a thickness of the gate electrode is at least about 400 Å.

20. The electron emission device of claim 18, wherein the non-oxide metal comprises Al, and a thickness of the gate electrode is at least about 250 Å.

21. The electron emission device of claim 18, wherein the non-oxide metal comprises Mg₁₀Ag₁, and a thickness of the gate electrode is at least about 200 Å.

22. The electron emission device of claim 18, wherein the non-oxide metal comprises Ag and at least one element selected from the group consisting of the Cr, Al, and Yb, and the at least one element and Ag are layered with each other in the gate electrode such that the at least one element is between the substrate and Ag.

23. The electron emission device of claim 16, wherein a thickness of the isolated electrode is at most about 30 nm.

24. The electron emission device of claim 16, wherein the ultraviolet transmittance of the main electrode is at least about 30%, and the main electrode comprises a non-oxide metal.

25. An electron emission device comprising:
a substrate;
a cathode electrode on the substrate and having a first opening, the cathode electrode comprising an ultraviolet non-transmitting material;
an electron emission region in the first opening and for emitting electrons; and
a gate electrode electrically insulated from the cathode electrode and having a second opening through which the electrons emitted from the electron emission region pass, the gate electrode having an ultraviolet transmittance of at least about 30%,
wherein a distance between a center of the electron emission region and a center of the second opening is at most about 0.5 μm in a direction perpendicular to an extending direction of the cathode electrode.
